(19) United States
(12) Patent Application Publication
(10) Pub. No.: US 2026/0052070 A1
(43) Pub. Date: Feb. 19, 2026

(54) ACCURATE AND FAST ESTIMATION OF TEMPORAL MOTIFS USING PATH SAMPLING

(71) Applicants: REGENTS OF THE UNIVERSITY OF MICHIGAN, Ann Arbor, MI (US); THE REGENTS OF THE UNIVERSITY OF CALIFORNIA, Oakland, CA (US)

(72) Inventors: Nishil Rakeshkumar Talati, Ann Arbor, MI (US); Yunje Pan, Ann Arbor, MI (US); Seshadhri Comandur, Santa Cruz, CA (US); Omkar Vivek Bhalerao, Santa Cruz, CA (US)

(21) Appl. No.: 19/300,260

(22) Filed: Aug. 14, 2025

Related U.S. Application Data
(60) Provisional application No. 63/683,048, filed on Aug. 14, 2024.

(51) Int. Cl. H04L 41/14

(52) U.S. Cl. CPC H04L 41/145

(57) ABSTRACT

The methods and systems described herein relate to analyzing and estimating patterns within graph structures. A method may include receiving indications of a specified time window and a specified temporal motif; selecting an anchor three-path, determining anchor edge directions and time sequences; receiving an indication of a graph; calculating an edge sampling probability for each graph edge; randomly selecting a center graph edge set; randomly selecting a sample three-path; determining a count of temporal motif instances; and calculating and outputting the motif count estimate.

### CROSS-REFERENCE TO RELATED APPLICATIONS

This application claims priority to and the benefit of U.S. Provisional Application No. 63/683,048, filed Aug. 14, 2024, and entitled “Accurate and Fast Estimation of Temporal Motifs Using Path Sampling”, which is incorporated herein by reference in its entirety.

### STATEMENT OF GOVERNMENT SUPPORT

This invention was made with government support under CCF-1740850 and DMS-2023495 awarded by the National Science Foundation. The government has certain rights in the invention.

### FIELD OF THE INVENTION

The present aspects relate to computer-implemented methods and systems for analyzing and estimating patterns within graph structures, and more particularly, to techniques for estimating temporal connected four node motif instances in a graph by utilizing sampling based on edge characteristics and temporal constraints, such as calculating a motif count estimate based on the count of the temporal connected motif instances.

### BACKGROUND

Mining small subgraph patterns, referred to as motifs, is a central problem in network analysis. Motif mining plays a critical role in understanding the structure and function of complex systems encoded as graphs. There is a rich body of work on mining motifs in static graphs. Most real-world phenomena representing networks, e.g., social interaction, communication, are dynamic, where edges are created with timestamps. Static graphs are built by omitting crucial temporal information. Temporal edges between nodes are tuples (u, v, t), where u and v are source and destination nodes, and t is the timestamp of the edge. Edges with timestamps capture richer information compared to static edges. A graph with such temporal edges is called a temporal graph, and patterns in such graphs are called temporal motifs. Temporal motifs are useful in user behavior characterization on social/communication networks, detecting fraud in financial transaction networks, and characterizing the structure and function of biological networks. Furthermore, local motif counts are useful to resolve symmetries and improve the expressive power of graph neural networks (GNNs).

Motif counting in directed, temporal graphs is especially challenging because there is a plethora of different kinds of patterns. Temporal motif counts reveal much richer information and there is a need for scalable algorithms for motif counting. A major challenge in counting is that there can be trillions of temporal motif matches even with a graph with only millions of nodes, i.e., vertices. Both the motifs and the input graphs can have multiple edges between two nodes, leading to a combinatorial explosion problem. Counting temporal motifs including just four nodes is not feasible with current state-of-the-art algorithms.

### SUMMARY

The following relates to systems and methods for counting motifs. Disclosed herein are techniques that address this problem using temporal path sampling. The disclosed techniques combine a path sampling method with carefully designed temporal data structures, to propose an efficient approximate algorithm for temporal motif counting. The disclosed techniques are unbiased estimators with provable concentration behavior that can be used to bound the estimation error. For a Bitcoin graph with hundreds of millions of edges, the disclosed techniques run in less than one minute, while the exact counting algorithm takes more than a day. The accuracy of these techniques has been empirically demonstrated on large datasets, showing an average of 30× speedup (up to 2000× speedup) compared to existing graphics processing unit (GPU)-based exact counting methods, while preserving high count estimation accuracy.

In one aspect, a computer-implemented method of estimating temporal connected four node motif instances in a graph includes: (1) receiving, by one or more processors, an indication of a specified time window and an indication of a specified temporal motif, wherein the specified temporal motif comprises a set of motif edges, each motif edge of the set of motif edges comprises a respective source node, a respective destination node, and an edge time order; (2) selecting, by the one or more processors, an anchor three-path from the specified temporal motif, wherein the anchor three-path comprises a center anchor edge, a first anchor edge, and a second anchor edge from the set of motif edges, wherein the center anchor edge and the first anchor edge are incident to a first anchor node, and the center anchor edge and the center anchor edge are incident to a second anchor node; (3) determining, by the one or more processors from the specified time window and the anchor three-path, a first anchor edge direction, a first anchor edge time sequence, a second anchor edge direction, and a second anchor edge time sequence; (4) receiving, by the one or more processors, an indication of the graph, wherein the graph comprises a set of graph edges, wherein each graph edge of the set of graph edges comprises a respective graph source node, a respective graph destination node, and an edge time; (5) calculating, by the one or more processors, an edge sampling probability for each graph edge of the graph; (6) randomly selecting, by the one or more processors based on the edge sampling probability, a center graph edge set comprising a subset of the set of graph edges; (7) for each center graph edge of the center graph edge set, randomly selecting by the one or more processors, a sample three-path comprising the center graph edge, a first respective graph edge, and a second respective graph edge, wherein the center graph edge and the first respective graph edge are incident to a first respective graph node, the center graph edge and the second respective graph edge are incident to a second respective graph node, an edge direction and the edge time of the first respective graph edge satisfies the edge direction and the edge time order of the first anchor edge, and an edge direction and the edge time of the second respective graph edge satisfies the edge direction and the edge time order of the second anchor edge; (8) for each sample three-path, determining, by the one or more processors, a count of temporal motif instances comprising the sample three-path and one or more additional graph edges satisfying the set of motif edges; (9) calculating, by the one or more processors, the motif count estimate for the graph based on the count of the temporal motif instances; and/or (10) outputting, by the one or more processors, the motif count estimate.

In one aspect, a system for estimating temporal connected four node motif instances in a graph includes: (A) one or more processors; (B) a memory storing instructions that cause the one or more processors to: (1) receive an indication of a specified time window and an indication of a specified temporal motif, wherein the specified temporal motif comprises a set of motif edges, each motif edge of the set of motif edges comprises a respective source node, a respective destination node, and an edge time order; (2) select an anchor three-path from the specified temporal motif, wherein the anchor three-path comprises a center anchor edge, a first anchor edge, and a second anchor edge from the set of motif edges, wherein the center anchor edge and the first anchor edge are incident to a first anchor node, and the center anchor edge and the center anchor edge are incident to a second anchor node; (3) determine, from the specified time window and the anchor three-path, a first anchor edge direction, a first anchor edge time sequence, a second anchor edge direction, and a second anchor edge time sequence; (4) receive an indication of the graph, wherein the graph comprises a set of graph edges, wherein each graph edge of the set of graph edges comprises a respective graph source node, a respective graph destination node, and an edge time; (5) calculate an edge sampling probability for each graph edge of the graph; (6) randomly select, based on the edge sampling probability, a center graph edge set comprising a subset of the set of graph edges; (7) for each center graph edge of the center graph edge set, randomly selecting a sample three-path comprising the center graph edge, a first respective graph edge, and a second respective graph edge, wherein the center graph edge and the first respective graph edge are incident to a first respective graph node, the center graph edge and the second respective graph edge are incident to a second respective graph node, an edge direction and the edge time of the first respective graph edge satisfies the edge direction and the edge time order of the first anchor edge, and an edge direction and the edge time of the second respective graph edge satisfies the edge direction and the edge time order of the second anchor edge; (8) for each sample three-path, determine a count of temporal motif instances comprising the sample three-path and one or more additional graph edges satisfying the set of motif edges; (9) calculate the motif count estimate for the graph based on the count of the temporal motif instances; and/or (10) output the motif count estimate.

### BRIEF DESCRIPTION OF THE DRAWINGS

The figures described below depict various aspects of the methods and systems disclosed herein. It should be understood that each figure depicts one embodiment of a particular aspect of the disclosed systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an exemplary temporal motif estimating system, according to some aspects.

FIG. 2A depicts an example of mining a temporal motif from an input graph, according to some aspects.

FIG. 2B depicts exemplary temporal motifs, according to some aspects.

FIG. 3 depicts an example of a temporal motif and a three-path, according to some aspects.

FIG. 4A depicts a temporal directed graph, according to some aspects.

FIG. 4B depicts exemplary adjacency lists, according to some aspects.

FIG. 5 depicts a flow diagram of an exemplary method for estimating a count of temporal motifs, according to some aspects.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The present techniques introduce a computer-implemented method for estimating temporal four-node motif instances in a graph, addressing the challenge of efficiently analyzing complex network structures over time. These techniques leverage a novel approach to sampling and estimating the occurrences of specific patterns, or motifs, within directed, temporal graphs. Directed, temporal graphs are a fundamental representation in various domains, capturing the dynamics of interactions within networks by considering the direction and timing of connections between nodes. The ability to estimate the count of temporal motifs accurately and rapidly in such graphs is crucial for understanding the underlying structure and dynamics of complex systems, ranging from social networks to biological networks to financial transaction networks.

The present techniques focus on the concepts of δ-centered three-paths. In particular, the techniques use δ-centered three-paths to obtain accurate estimates of motif-counts for patterns on four nodes. This is primarily because counting motifs on four nodes is more challenging than triangles, and all of the disclosed techniques can be easily generalized to patterns involving three nodes.

The present techniques accurately estimate the number of connected three- or four-vertex temporal motifs by sampling a subset of temporal three-paths, whose edges must satisfy certain temporal constraints, and then determine the motif counts. The present techniques comprise three primary phases: 1) preprocessing to get sampling weights, 2) sampling three-paths, and 3) deriving desired motif counts from the sampled three-paths.

One of the primary improvements introduced by the present techniques is the enhancement of processing efficiency. Traditional methods for counting temporal motifs, especially those involving four vertices, face significant challenges due to the combinatorial explosion problem. This problem arises when attempting to identify all instances of a motif within large graphs, leading to impractical computation times even for state-of-the-art algorithms. The present techniques address this issue by employing a path sampling method that significantly reduces the computational burden. This approach allows for the rapid estimation of motif counts, achieving a substantial speedup compared to existing methods without sacrificing accuracy.

Furthermore, the present techniques improve network usage in distributed computing environments. The systems and methods facilitate parallel processing, allowing different parts of the graph to be sampled and analyzed concurrently across multiple processors. This parallelism, combined with the inherent efficiency of the systems and methods, enables the scalable analysis of vast networks, making it feasible to apply the technique to real-world datasets of significant size and complexity.

In summary, the present techniques introduce an innovative approach to estimating temporal four-node motif instances in directed, temporal graphs. By leveraging path sampling and carefully designed temporal data structures, these techniques offer a fast, accurate, and efficient solution to a challenging problem in network analysis. The improvements in processing efficiency and network usage represent a substantial advancement over existing methods, opening new avenues for research and application in various fields.

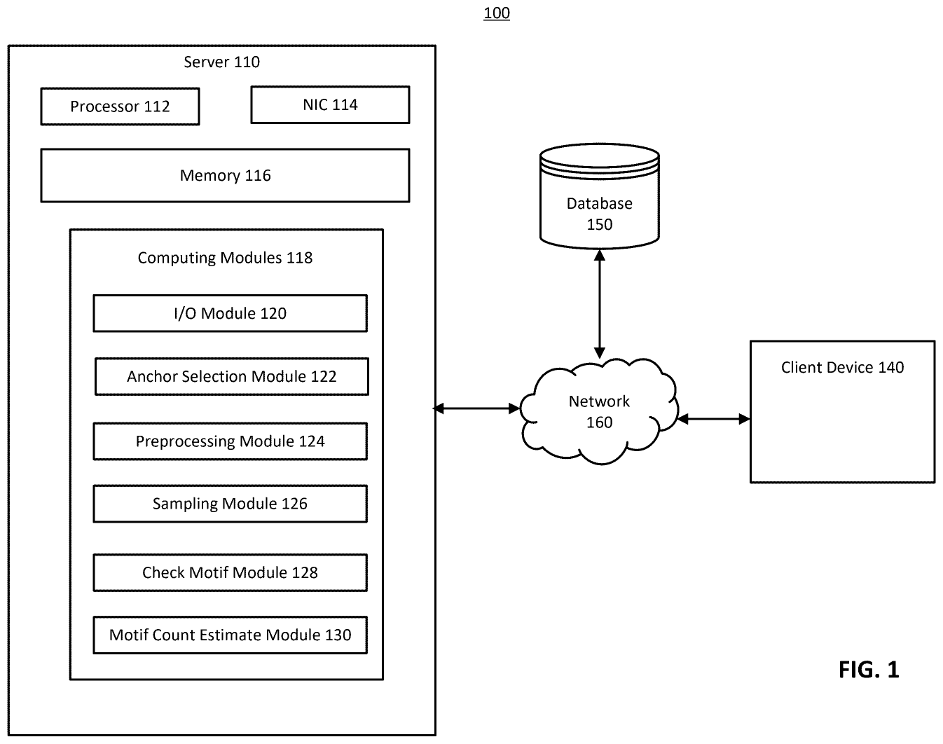

FIG. 1 depicts a block diagram of an exemplary computing environment 100 in which methods and systems for estimating temporal connected four-node motif instances in a graph may be performed, in accordance with various aspects discussed herein. As illustrated, the exemplary computing environment 100 includes a server 110, client device 140, database 150, and network 160.

As described herein and in an aspect, the server 110 may receive constraints and parameters, retrieve a specified temporal motif and a graph, and estimate a count of temporal motifs in graph. The server 110 may include a processor 112, network interface card (NIC) 114, and memory 116.

The processor 112 may include one or more suitable processors (e.g., central processing units (CPUs) and/or graphics processing units (GPUs)). The processor 112 may be connected to the memory 116 via a computer bus (not depicted) responsible for transmitting electronic data, data packets, or otherwise electronic signals to and from the processor 112 and memory 116 in order to implement or perform the machine-readable instructions, methods, processes, elements or limitations, as illustrated, depicted, or described for the various flowcharts, illustrations, diagrams, figures, and/or other disclosure herein. The processor 112 may interface with the memory 116 via a computer bus to execute an operating system (OS) and/or computing instructions contained therein, and/or to access other services/aspects. For example, the processor 112 may interface with the memory 116 via the computer bus to create, read, update, delete, or otherwise access or interact with the data stored in the memory 116.

The network interface card (NIC) 114 may include any suitable network interface controller(s), such as wired/wireless controllers (e.g., Ethernet controllers), and facilitate bidirectional/multiplexed networking over the network 160 between the server 110 and other components of the environment 100 (e.g., the client device 140, the database 150, etc.).

The memory 116 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 116 may store an operating system (OS) (e.g., Microsoft Windows, Linux, UNIX, MacOS, etc.) capable of facilitating the functionalities, apps, methods, or other software as discussed herein.

The memory 116 may load one or more computing modules 118, implemented as respective sets of computer-executable instructions (e.g., one or more source code libraries, input/output modules, etc.) as described herein. The computing modules 118 may include computer-readable program code or computer instructions adapted to be executed by the processor(s) 112 (e.g., working in connection with the respective operating system in memory 116) to facilitate, implement, or perform the machine readable instructions, methods, processes, elements or limitations, as illustrated, depicted, or described for the various flowcharts, illustrations, diagrams, figures, and/or other disclosure herein. In this regard, the computing modules 118 may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

In one aspect, the computing modules 118 may include an input/output (I/O) module 120 comprising a set of computer-executable instructions implementing communication functions. The I/O module 120 may include a communication component configured to communicate (e.g., send and receive) data via one or more external/network port(s) to one the client device 140, database 150, and/or another device via the network 160. In one aspect, the server 110 may include a client-server platform technology such as ASP .NET, Java J2EE, Ruby on Rails, Node.js, a web service or online API, responsive for receiving and responding to electronic requests.

The I/O module 120 may further include or implement an operator interface configured to present information to an administrator or operator and/or receive inputs from the administrator and/or operator. An operator interface may provide a display screen. The I/O module 120 may facilitate I/O components (e.g., ports, capacitive or resistive touch sensitive input panels, keys, buttons, lights, LEDs), which may be directly accessible via, or attached to, the server 110. According to an aspect, an administrator or operator may access the server 110 from a client device 140 via the I/O module 120 to initiate a motif count estimate, provide input parameters, review output information, and/or perform other functions.

In one aspect, the computing modules 118 may include an anchor selection module 122. The anchor selection module 122 receives a specified temporal motif as input. The anchor selection module 122 selects an anchor δ-centered three-path from the specified temporal motif.

In one aspect, the computing modules 118 may include a preprocessing module 124. The preprocessing module 124 calculates a sampling probability for each edge in the graph and a total sampling weight for the graph. The preprocessing module 124 may calculate the sampling probability and total sampling weight based on a specified time window and other criteria.

In one aspect, the computing modules 118 may include a sampling module 126. The sampling module 126 randomly selects a specified number of center edges from the graph based on the sampling probability. The sampling module 126 randomly selects an anchor three-path comprising the center edge for each center edge.

In one aspect, the computing modules 118 may include a check motif module 128. The check motif module 128 determines the existence of a motif for each anchor three-path and returns a motif count for the anchor three-path.

In one aspect, the computing modules 118 may include a motif count estimate module 130. The motif count estimate module 130 provides an estimate of the total number of temporal motifs in the graph based upon the motif count, the specified number of center edges, and the total sampling weight.

The client device 140 may include any suitable device and include one or more desktop computers, laptop computers, server computers, smartphones, tablets, and/or other electronic or electrical component. The client device 140 may include a memory and a processor for, respectively, storing and executing one or more modules. The memory may include one or more suitable storage media such as a magnetic storage device, a solid-state drive, random access memory (RAM), etc. The client device 140 may access services or other components of the computing environment 100 via the network 160.

The database 150 may be a relational database, such as Oracle, DB2, MySQL, a NoSQL based database, such as MongoDB, a graph database, such as Neo4j, or another suitable database. The database 150 may store one or more temporal motifs comprising a plurality of nodes and a plurality of edges. Each motif edge may have a source node, a destination node, and a time order. The database 150 may store one or more graphs comprising a plurality of nodes and a plurality of edges. Each graph edge may have a source node, a destination node, and an edge time. The database 150 may store the one or more temporal motifs as an adjacency list, and the adjacency list may be sorted by the time order. The database 150 may store the one or more graphs as an adjacency list, and the adjacency list may be sorted by the edge time. In some embodiments, the database 150 may store the one or more temporal motifs and/or the one or more graphs in the graph data format (GDF), which contains comma separated values.

The network 160 may be a single communication network or may include multiple communication networks of one or more types (e.g., one or more wired and/or wireless local area networks (LANs), and/or one or more wired and/or wireless wide area networks (WANs) such as the Internet). The network 160 may enable bidirectional communication between the server 110 and the database 150, the server 110 and the client device 140, and/or between other computing devices/instances, for example.

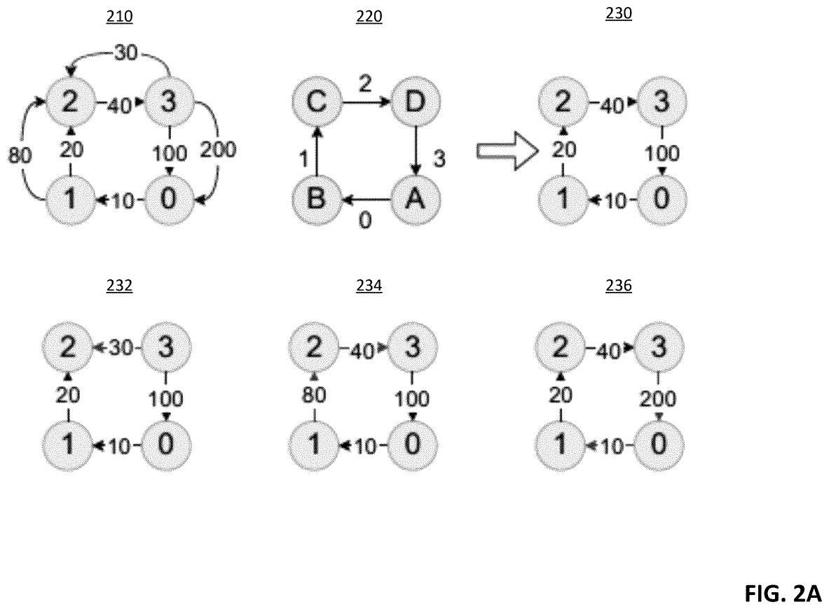

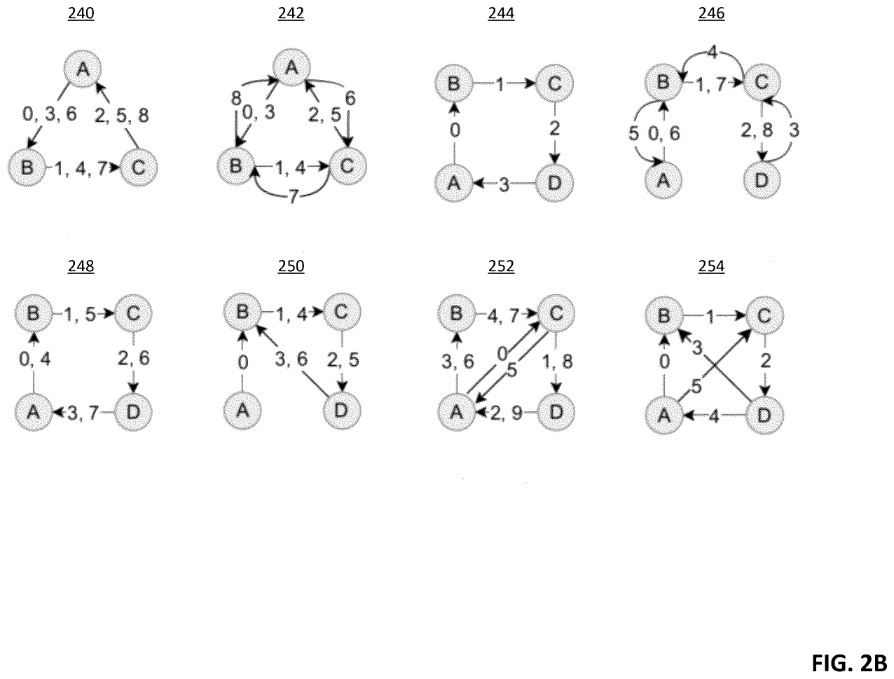

FIG. 2A depicts an input graph 210, a temporal motif 220, a valid match 230, and invalid matches 232, 234, and 236. The input graph 210 is a directed temporal graph G=(V(G), E(G)), with a vertex set V and edge set E. In the illustrated example, the input graph 210 has four vertices and seven edges. Each edge is a tuple e=(u, v, t), where u and v are vertices and t is a positive integer timestamp. The edges are directed, and there may be one or more edges between u and v.

A temporal motif, such as temporal motif 220, is a triple M=(H, π, δ) where (i) H=(V(H), E(H)), (ii) π is a permutation on the edges of H, and (iii) δ is a positive integer. H is a directed pattern multigraph, the permutation specifies the time ordering of edges, and δ is a time window that specifies the length of time interval for all edges. In the example of temporal motif 220, π=((A,B,0), (B,C,1), (C,D,2), (D,A,3)) and δ=100.

For an input temporal graph G, such as input graph 210, G=(V(G), E(G)) and a temporal pattern M=(H, π, δ). An M-match is a 1-1 map ϕ: V(H)→V(G) satisfying three conditions: (1) matching the pattern, (2) edges ordered correctly, and (3) edges within the time interval. The pattern is matched when the map ϕ matches the edges of H. Formally, ∀(u, v) ∈ E(H), (ϕ(u), ϕ(v)) ∈ E(G). For convenience, for edge e ∈ E(H), ϕ (e) may be used to denote the match in the pattern. Edges are ordered correctly when the timestamps of the edges in the match follow the ordering π. Formally, ∀e, e′ ∈ E(H), π(e)<π(e′) iff t(ϕ(e))<t(ϕ(e′)). Edges are within the time interval when all edges of the match occur within δ time window. ∀e, e′ ∈ E(H), |t(ϕ(e))−t(ϕ(e′))|≤δ.

In the example of FIG. 2A, the objective is to mine the temporal motif 220 with 0=100 sec from the input graph 210. FIG. 2A shows one valid match 230 and three invalid matches 232, 234, and 236. Valid match 230 matches the pattern of temporal motif 220, the edges are ordered correctly, and the edges are within the time interval, δ=100 sec. Invalid match 232 is invalid due to the edge direction between nodes 2 and 3 is opposite to the pattern in temporal motif 220. Invalid match 234 is invalid because edge (1, 2, 80) occurs after edge (2, 3, 40), which violates the edge ordering constraints in temporal motif 220. And invalid match 236 is invalid because the edge (3, 0, 200) occurs 190 seconds after the first edge (0, 1, 10), exceeding the maximum time window δ.

FIG. 2B depicts examples of connected temporal motifs 240-254. Temporal motifs 240 and 242 are three-node temporal motifs, and temporal motifs 244-254 are four-node temporal motifs. Each of the four-node temporal motifs 244-254 includes at least one three-path. Each temporal motif may have a plurality of edges between any two nodes. For example, temporal motif 252 includes ten edges. A match to temporal motif 252 must include ten edges satisfying the edge pattern, direction, and timestamp orderings.

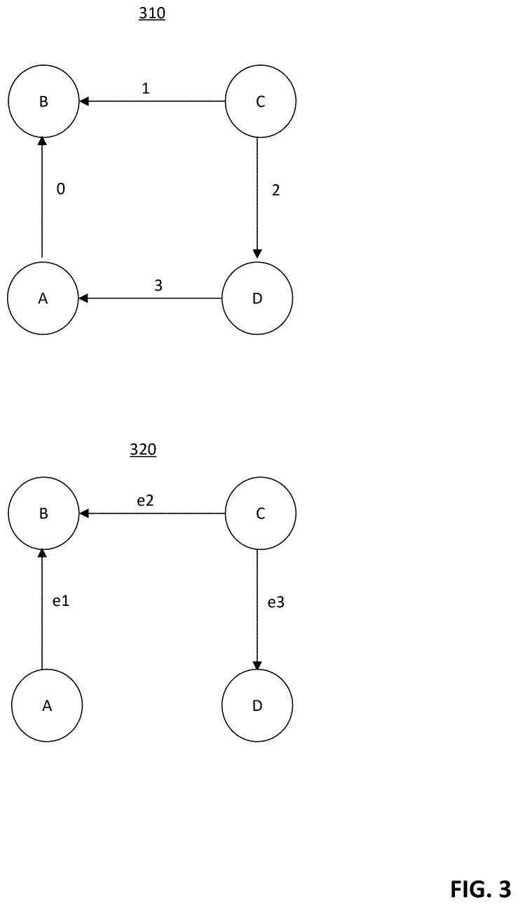

FIG. 3 depicts an example of a temporal motif 310 and an example of a δ-centered three-path 320. The temporal motif 310 includes four nodes, A, B, C, and D, and four edges in the time order ((A,B,0), (C,B,1), (C,D,2), (D,A,3)). A δ-centered three-path, such as δ-centered three-path 320, is a sequence of three edges e₁, e₂, e₃ with the following properties. Let e₂=(C, B, t(e₂)). Then, e₁ is incident to B, and e₃ is incident to C. Furthermore, |t(e₁)−t(e₂)|≤δ and |t(e₃)−t(e₂)|≤δ. In particular, a δ-centered three-path is a sequence of three “connected” edges with both end edges e₁ and e₃ within time δ of the center edge e₂. A key observation is that such temporal three-paths may be sampled rapidly. There is no δ constraint between t(e₁) and t(e₃). Also, e₁ and e₃ may potentially intersect (at a node). Further, e₁ and e₃ may contain both B and C. Technically, this forms a homomorphism of a three-path. This definition of end edges e₁ and e₃ allows for easy sampling while maintaining some temporal constraints.

Temporal three-paths may be classified into sixteen classes indexed by four-bit binary tuples. Specifically, the three-path classes are denoted [symbol] α₁, α₃, β₁, β₃ [symbol] , where α₁, α₃ ∈ {+,−} and β₁, β₃ ∈ {<, >}. αᵢ, βᵢ represent a constraint on the edge eᵢ of a δ-centered three-path, where such that α₁ is the first edge direction, α₃ is the second edge direction, β₁ is the first edge time order, and β₃ is the second edge time order. For example, the class of [symbol] −, +, <, > [symbol] δ-centered three-paths contains all paths of the following form. Let (e₁, e₂, e₃) be a δ-centered three-path and e₂=(B, C, t) be the center edge. Then e₁ is an in-edge (−) of B (as specified by the first edge direction, α₁) and e₃ is an out-edge (+) of C (as specified by the second edge direction, α₃). Also, t(e₁)<t(e₂) (as specified by the first edge time order, β₁) and t(e₃)>t(e₂) (as specified by the second edge time order, β₃). There is no condition between e₁ and e₃.

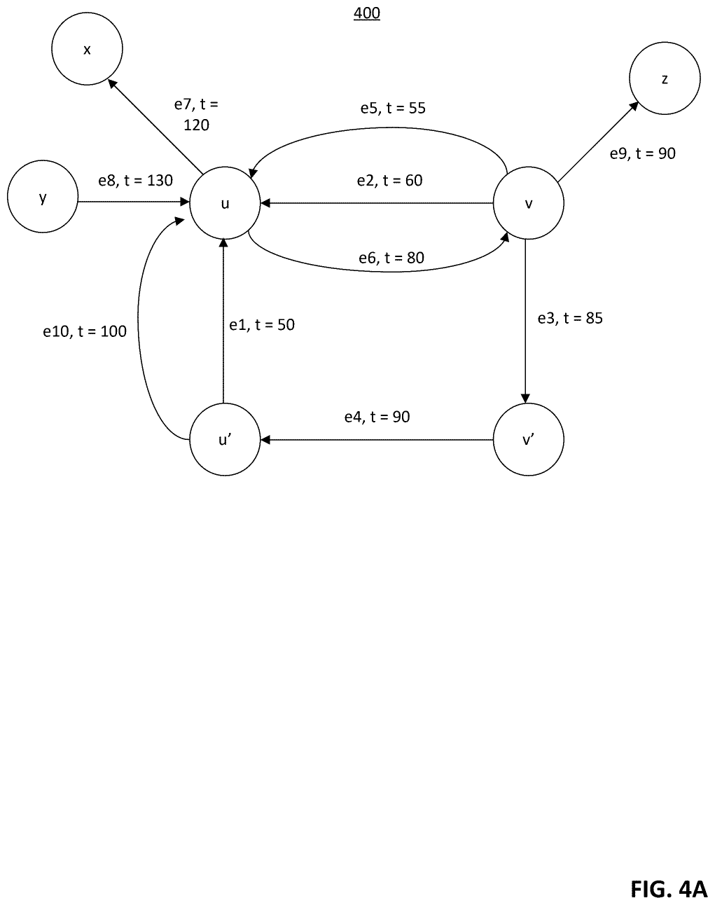

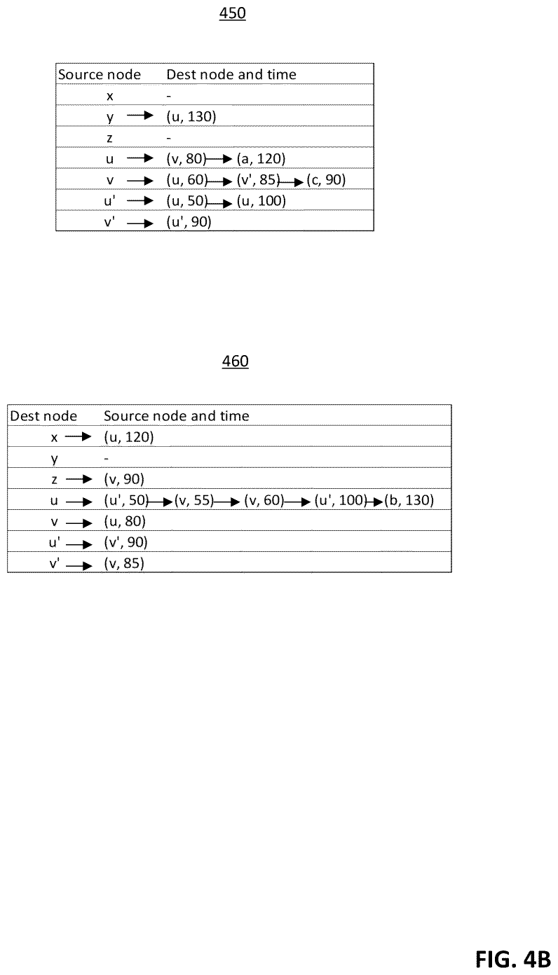

FIG. 4A depicts an example of a directed temporal graph 400. In the illustrated example, the directed temporal graph 400 has seven nodes: u, v, u′, v′, x, y, and z, and ten edges, e1-e10. The present techniques may perform a binary search by time among the edges incident to a node. The present techniques may be used for all sixteen classes of three-paths: [symbol] α₁, α₃, β₁, β₃ [symbol] . In some embodiments, a user, via client device 140 and the I/O module 120, may specify a four-node motif M and/or an anchor S, which is a three-path chosen from M, as inputs. For example, the user may specify M as the temporal motif 310. In some embodiments, one or more computing modules 118, such as the anchor selection module 122, randomly select the anchor S from the specified four-node motif M. In some embodiments, the anchor selection module 122 selects the anchor S that includes the lowest time-order edge of M.

FIG. 4B depicts an adjacency out-list 450 and an adjacency in-list 460 for the directed temporal graph 400. The adjacency out-list 450 may include linked lists for each of the plurality of source nodes. For each out-edge, there may be a link to a tuple comprising the destination node and the time. Each linked list may be sorted in ascending time order. Likewise, the adjacency in-list 460 may include linked lists for each of the plurality of destination nodes. For each in-edge, there may be a link to a tuple comprising the source node and the time. Each linked list may be sorted in ascending time order. The adjacency out-list 450 and adjacency in-list 460 may be stored in the memory 116 or the database 150.

In some embodiments, the preprocessing module 124 calculates a temporal outlist ∧ᵥ⁺, a temporal inlist ∧ᵥ, a temporal out-degree dᵥ⁺ [t, t′], and/or a temporal in-degree dᵥ⁻ [t, t′]. Given a node v and natural numbers t, δ, the temporal outlist ∧ᵥ⁺ [t, t′] is defined as the set of outedges (v, w, t″), where w is an arbitrary node and t″∈ [t, t′]. Likewise, the temporal inlist is defined as ∧ᵥ⁺ [t, t′]. The temporal out-degree dᵥ⁺ [t, t′] denotes the size of the temporal outlist ∧ᵥ⁺ [t, t′], and the temporal in-degree dᵥ⁺ [t, t′] denotes the size of the temporal inlist ∧ᵥ⁻ [t, t′]. In the illustrated example of directed temporal graph 400 where the [symbol] −, +, <, > [symbol] class is chosen and δ is set to 50 sec, for the edge e2 having time of 60 seconds, the temporal inlist of node u, ∧ᵤ⁻ [t−δ, t], includes inedges e1, e2, and e5, and the temporal in-degree dᵤ⁻ [t−δ, t]=3. The temporal outlist of node v, ∧ᵥ⁺ [t, t+δ], includes outedges e2, e3, and e9, and the temporal out-degree dᵥ⁺ [t, t+δ]=3.

In some embodiments, the preprocessing module 124 calculates a sample weight, which is the three-path count, for each edge of the directed temporal graph 400. For a temporal edge e=(u, v, t), W_{e,δ} denotes the number of δ-centered three-paths satisfying the anchor S. For an anchor S of the [symbol] −, +, <, > [symbol] class, the preprocessing module 124 calculates the sample weight of an edge e given the following formula: W_{e,δ}=dᵤ⁻ [t−δ, t]·dᵥ⁺ [t, t+δ]. Returning to the illustrated example of directed temporal graph 400, the sample weight of e2, W_{e2,δ} is dᵤ⁻ [10, 60]·dᵥ⁺ [60, 110]=3*3=9. That is, there are nine-centered three-paths with e2 as the center edge and satisfying the anchor S. In some embodiments, the preprocessing module 124 calculates a total sampling weight W_{δ} for the directed temporal graph 400. The total sampling weight is the sum of the sampling weights for each edge, W_{δ}: =ΣₑW_{e,δ}. In some embodiments, the preprocessing module 124 calculates a sampling probability p_{e,δ} for each edge in the directed temporal graph 400. The sampling probability is the sample weight of the edge divided by the total sampling weight, p_{e,δ}=W_{e,δ}/W_{δ}.

Exemplary pseudocode for the preprocessing module 124 is presented below. Given a time window δ and an anchor S of the class [symbol] −, +, <, > [symbol] , the preprocessing module 124 outputs the sampling probability p_{e,δ} for each edge e1-e10 in the directed temporal graph 400 and outputs the total sampling weight W_{δ}.

PREPROCESS(δ)

1: for n ∈ {u, v, u′, v′, x, y, z} do

| | |
|---|---|
| 2: | In the in-neighbor list of n, search for the times t − δ and t. Store the |

difference in indices dₙ⁻ [t−δ, t].

| | |
|---|---|
| 3: | In the out-neighbor list of n, search for the times t and t + δ. Store the |

difference in indices dₙ⁺ [t, t+δ]
4: W_{δ} = 0
5: for e = (n₁, n₂, t) ∈ {e1, e2, e3, e4, e5, e6, e7, e8, e9, e10} do

| | |
|---|---|
| 6: | w_{e,δ} = dₙ₁⁻ [t − δ, t] · dₙ₂⁺ [t, t + δ] |
| 7: | W_{δ} += w_{e,δ} |

8: for e = ∈ {e1, e2, e3, e4, e5, e6, e7, e8, e9, e10} do

| | |
|---|---|
| 9: | p_{e,δ} = w_{e,δ} / W_{δ} |

The sampling module 126 computes a random three-path based on the probability distribution {p_{e,δ}}. In one embodiment, the sampling module 126 randomly selects a center graph edge set based upon the probability p_{e,δ}. The center graph edge set includes a subset of the set of graph edges. For example, based on the anchor path S, the sampling module 126 generates a uniform random [symbol] −, +, <, > [symbol] δ-centered three-path. The sampling module 126 may pick a center edge e=(n₁, n₂, t) with probability p_{e,δ}. In the example of directed temporal graph 400, the sampling module 126 randomly picks the edge e2=(v, u, 60). The sampling module 126 generates the in-neighbor list of node u having times between t−δ and t to get ∧ᵤ⁻ [10, 60], which includes edges e1, e2, and e5. The sampling module 126 generates the out-neighbor list of node v having times between ∧ᵥ⁺ [60, 110], which includes edges e2, e3, and e9. The sampling module 126 then picks a uniform random edge from ∧ᵤ⁻ [10, 60] and picks a uniform random edge from ∧ᵥ⁺ [60, 110]. In this example, the sampling module 126 picks edges e1 and e3 and thus outputs the δ-centered three-path P(e1, e2, e3). Exemplary pseudocode for the sampling module 126 is presented below.

SAMPLE(p_{e,δ}, δ)

1: Pick edge e = (u, v, t) with probability p_{e,δ}.
2: In the in-neighbor list of u, binary search for the times t − δ and t to get ∧ᵤ⁻[t
− δ, t].
3: Pick uniform random edge e1 from ∧ᵤ⁻[t − δ, t].
4: In the out-neighbor list of v, binary search for the times t and t + δ to get
∧ᵥ⁺[t, t + δ].
5: Pick uniform random edge e3 from ∧ᵥ⁺[t, t + δ].
6: return P = (e1, e, e3)

Once the sampling module 126 has sampled a three-path P matching the anchor S from the temporal directed graph 400, the check motif module 128 determines if the three-path P can be “extended” to count desired motifs, e.g., the specified motif 310. The list of edges (n₁, n₂, t) in temporal directed graph 400 are designated as L_{(n1,n2)}. The check motif module 128 may take the three-path P, the motif M(H, π, δ), and the anchor S as inputs and may return the count of the temporal motif matches. This anchor S includes the motif edge with the earliest time stamp, labeled as time order 0. Continuing with the example of the directed temporal graph 400 in FIG. 4A, check motif module 128 selects the three-path 320 anchor that includes the sequence ((A,B,0), (C,B,1), (C,D,2)). The check motif module 128 takes a sampled three-path P as input and returns the count of the matches to temporal motif 310 where P maps to the anchor S. The check motif module 128 may first check if the sampled three-path P is a valid match to anchor S in M by verifying that the three-path spans four nodes, the edge timestamps are in the correct order, and/or the edge timestamps are within the time window δ. Continuing the example of temporal motif 310 and three-path 320 anchor, the sampled-three path P(e1, e2, e3) matches the three-path 320 anchor because P spans four nodes (u′,u,v,v′), the edge timestamps are in the correct order (50, 60, 85), and the edge timestamps are within the time window δ(85<=50+50).

After verifying a valid match, the check motif module 128 may determine the number of matches of M that have P mapped to the anchor path S. For the example of the temporal motif 310 and the three-path 320 anchor, the check motif module 128 must find an additional match to the edge (D,A,3). The adjacency out-list 450 and adjacency in-list 460 are sorted by time. So, using binary search, the check motif module 128 finds a sublist of edges, designated L_{(v′u′)} in the graph matching those edges whose timestamp is within δ of P and is larger than all timestamps in P. For the temporal directed graph 400, the check motif module 128 finds match e4 (v′,u′, 90), where 90 is within δ of P and is larger than all timestamps in P. The check motif module 128 then counts the number of tuples of edges from the sublists L_{(n1,n2)} that are not on the anchor path S; in this example, L_{(v′,u′)} is one.

Exemplary pseudocode for the check motif module 128 is presented below.

CHECKMOTIF(P, M)

| 1: if ({u′, u, v, v′} not all distinct) or (t3 > t1 + δ) then | |
|---|---|
| 2: | return 0 |

3: For every edge e of M that is not on the anchor path, use binary search to
find the sublist (in G) E_{f} of potential matches.
4: Number these lists as L₁, L₂, . . . L_{I} in the time ordering.
5: return count(L₁, L₂, . . . L_{I})

The motif count estimate module 130 calculates the estimated motif count C\hat{ }, which is the number of M-matches in the graph. The input to the motif count estimate module 130 is the temporal motif M (H, π, δ) and a sample number k. Exemplary pseudocode for the motif count estimate module 130 is presented below.

ESTIMATE(M, k)

1: Choose an anchor 3-path of M that has the smallest timeorder edge. Let
the 3-path be of type <α1, α3, β1, β3>.
2: {p_{e,δ}}, W_{δ} = PREPROCESS(δ) (for <α1, α3, β1, β3> class paths)
3: Initialize cnt = 0
4: for i ∈ [1, k] do

| | |
|---|---|
| 5: | Pᵢ = SAMPLE({p_{e,δ}}, δ) (for <α1, α3, β1, β3> class) |
| 6: | cnt = cnt + CHECKMOTIF(Pᵢ, M) |

7: return C^{\hat{ }} = (cnt/k) · W_{δ}

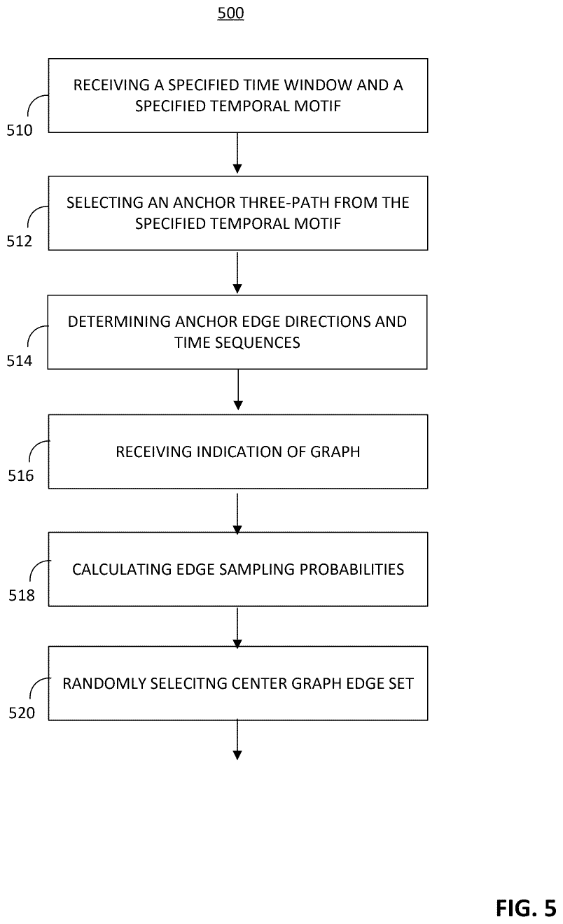

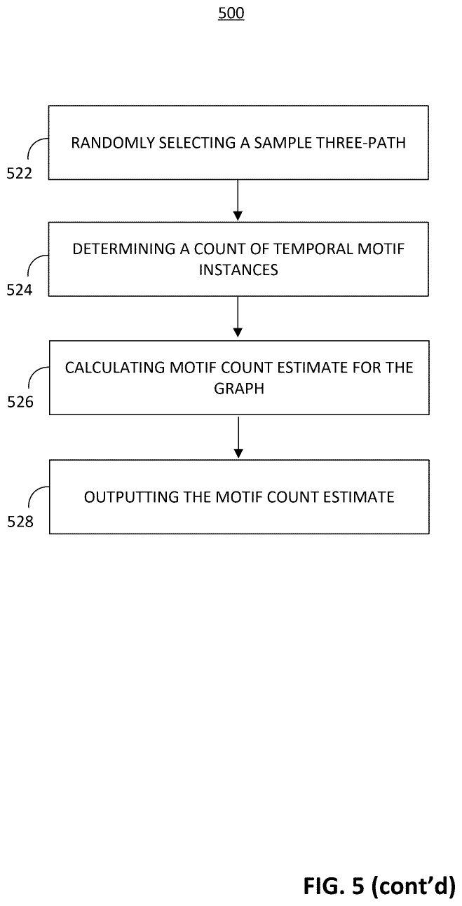

FIG. 5 depicts a flow diagram of an exemplary method 500 for estimating a count of temporal motifs in a graph, in accordance with various aspects discussed herein. One or more steps of the method 500 may be implemented as a set of instructions stored on a computer-readable memory and executable on one or more processors. The method 500 of FIG. 5 may be implemented via a system, such as the server 110. The method 500 may operate in conjunction with the scenarios and/or environments illustrated in FIGS. 1-4B and/or in other environments.

In some aspects, the method 500 may include at block 510 receiving an indication of a specified time window and/or receiving an indication of a specified temporal motif. The I/O module 120 may receive the specified time window and/or the specified temporal motif from the client device 140. The time window may be a duration specified in seconds, minutes, hours, or days. The specified temporal motif may be an adjacency list or a GDF file located in the client device 140, database 150, or some other location. The specified temporal motif may include a set of motif edges. Each motif edge of the set of motif edges may include a respective source node, a respective destination node, and an edge time order. The specified temporal motif may include four nodes. The specified temporal motif may include a motif adjacency list.

In some aspects, the method 500 may include at block 512 selecting an anchor three-path from the specified temporal motif. The user may manually select the anchor three-path or the anchor selection module 122 may automatically select the anchor three-path. The anchor three-path may include a center anchor edge, a first anchor edge, and a second anchor edge from the set of motif edges. The center anchor edge and the first anchor edge may be incident to a first anchor node. The center anchor edge and the center anchor edge may be incident to a second anchor node. The anchor three-path may include an edge having a lowest edge time order of the specified temporal motif.

In some aspects, the method 500 may include at block 514 determining from the specified time window and the anchor three-path, a first anchor edge direction, a first anchor edge time sequence, a second anchor edge direction, and a second anchor edge time sequence. The anchor selection module 122 may determine the first anchor edge direction, the first anchor edge time sequence, the second anchor edge direction, and the second anchor edge time sequence. Determining the first anchor edge direction may include determining whether the first anchor edge is an in-edge or an out-edge of the first anchor node. Determining the second anchor edge direction may include determining whether the second anchor edge is an in-edge or an out-edge of the second anchor node. Determining the first anchor edge time sequence may include determining whether the edge time order of the first anchor edge is less than or greater than the edge time order of the center edge. Determining the second anchor edge time sequence may include determining whether the edge time order of the second anchor edge is less than or greater than the edge time order of the center edge.

In some aspects, the method 500 may include at block 516 receiving an indication of the graph. The I/O module 120 may receive the indication of the graph. The graph may include a set of graph edges. Each graph edge of the set of graph edges may include a respective graph source node, a respective graph destination node, and an edge time. The graph may include a graph adjacency list or a GDF file.

In some aspects, the method 500 may include at block 518 calculating an edge sampling probability for each graph edge of the graph. The preprocessing module 124 may calculate the edge sampling probabilities. Calculating the edge sampling probability may include determining a first temporal degree comprising a count of the first graph edges that (i) are incident to the respective source node, (ii) satisfy the first anchor edge direction, (iii) satisfy the first anchor edge time sequence, and (iv) have an edge time within the specified time window from the graph edge. Calculating the edge sampling probability may include determining a second temporal degree comprising a count of the second graph edges that (i) are incident to the respective destination node, (ii) satisfy the second anchor edge direction, (iii) satisfy the second anchor edge time sequence, and (iv) have an edge time within the specified time window from the graph edge. Calculating the edge sampling probability may include multiplying the first temporal degree by the second temporal degree to calculate an edge sampling weight for the graph edge. Calculating the edge sampling probability may include summing each of the edge sampling weights to calculate a total sampling weight. Calculating the edge sampling probability may include dividing the edge sampling weight by the total sampling weight.

In some aspects, the method 500 may include at block 520 randomly selecting a center graph edge set comprising a subset of the set of graph edges. The random selection may be based on the edge sampling probability. The sampling module 126 may randomly select the center graph edge set. The center edge set may include a specified number of graph edges.

In some aspects, the method 500 may include at block 522 randomly selecting a three-path for each center graph edge of the center graph edge set. The sampling module 126 may randomly select the three-path. The sample three-path may include the center graph edge, a first respective graph edge, and a second respective graph edge. The center graph edge and the first respective graph edge may be incident to a first respective graph node. The center graph edge and the second respective graph edge may be incident to a second respective graph node. An edge direction and the edge time of the first respective graph edge may satisfy the edge direction and the edge time order of the first anchor edge. An edge direction and the edge time of the second respective graph edge may satisfy the edge direction and the edge time order of the second anchor edge. Randomly selecting the sample three-path may include determining that the first respective graph edge has an edge time within the specified time window from the edge time of the center edge. Randomly selecting the sample three-path may include determining that the second respective graph edge has an edge time within the specified time window from the edge time of the center edge.

In some aspects, the method 500 may include at block 524 determining a count of temporal motif instances for each sample three-path. The check motif module 128 may determine the count of temporal motif instances. The temporal motif instances may include the sample three-path and one or more additional graph edges satisfying the set of motif edges. Determining the count of temporal motif instances determining whether the temporal motif instance comprises four distinct nodes. Determining the count of temporal motif instances may include determining, for each motif edge not on the anchor three-path, a count of matching graph edges.

In some aspects, the method 500 may include at block 526 calculating a motif count estimate for the graph. The motif count estimate module 130 may calculate the motif count estimate. The motif count estimate may be calculated based on the count of the temporal motif instances. Calculating the motif count estimate may include calculating a total count of the temporal connected four node motif instances comprising a sum of the count of temporal connected four node motif instances. Calculating the motif count estimate may include dividing the total count of the temporal connected four node motif instances by a count of the subset of center edges to generate a temporal motif quotient. Calculating the motif count estimate may include multiplying the temporal motif quotient by the total sampling weight.

In some aspects, the method 500 may include at block 528 outputting the motif count estimate. The I/O module 120 may output the motif count estimate. The motif count estimate may be output to the client device 140.

### Additional Considerations

Although the preceding text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

1. A computer-implemented method of estimating a temporal connected motif count in a graph, comprising:
receiving, by one or more processors, an indication of a specified time window and an indication of a specified temporal motif, wherein the specified temporal motif comprises a set of motif edges, each motif edge of the set of motif edges comprises a respective source node, a respective destination node, and an edge time order;
selecting, by the one or more processors, an anchor three-path from the specified temporal motif, wherein the anchor three-path comprises a center anchor edge, a first anchor edge, and a second anchor edge from the set of motif edges, wherein the center anchor edge and the first anchor edge are incident to a first anchor node, and the center anchor edge and the second anchor edge are incident to a second anchor node;
determining, by the one or more processors from the specified time window and the anchor three-path, a first anchor edge direction, a first anchor edge time sequence, a second anchor edge direction, and a second anchor edge time sequence;
receiving, by the one or more processors, an indication of the graph, wherein the graph comprises a set of graph edges, wherein each graph edge of the set of graph edges comprises a respective graph source node, a respective graph destination node, and an edge time;
calculating, by the one or more processors, an edge sampling probability for each graph edge of the graph;
randomly selecting, by the one or more processors based on the edge sampling probability, a center graph edge set comprising a subset of the set of graph edges;
for each center graph edge of the center graph edge set, randomly selecting by the one or more processors, a sample three-path comprising the center graph edge, a first respective graph edge, and a second respective graph edge, wherein the center graph edge and the first respective graph edge are incident to a first respective graph node, the center graph edge and the second respective graph edge are incident to a second respective graph node, an edge direction and the edge time of the first respective graph edge satisfies the edge direction and the edge time order of the first anchor edge, and an edge direction and the edge time of the second respective graph edge satisfies the edge direction and the edge time order of the second anchor edge;
for each sample three-path, determining, by the one or more processors, a count of temporal motif instances comprising the sample three-path and one or more additional graph edges satisfying the set of motif edges;
calculating, by the one or more processors, the motif count estimate for the graph based on the count of the temporal motif instances; and
outputting, by the one or more processors, the motif count estimate.

2. The computer-implemented method of claim 1, wherein the specified temporal motif comprises four nodes.

3. The computer-implemented method of claim 1, wherein the specified temporal motif comprises a motif adjacency list and the graph comprises a graph adjacency list.

4. The computer-implemented method of claim 1, wherein the anchor three-path comprises an edge having a lowest edge time order of the specified temporal motif.

5. The computer-implemented method of claim 1, wherein determining the first anchor edge direction comprises determining whether the first anchor edge is an in-edge or an out-edge of the first anchor node, and determining the second anchor edge direction comprises determining whether the second anchor edge is an in-edge or an out-edge of the second anchor node.

6. The computer-implemented method of claim 1, wherein determining the first anchor edge time sequence comprises determining whether the edge time order of the first anchor edge is less than or greater than the edge time order of the center anchor edge, and determining the second anchor edge time sequence comprises determining whether the edge time order of the second anchor edge is less than or greater than the edge time order of the center anchor edge.

7. The computer-implemented method of claim 1, wherein calculating the edge sampling probability for each graph edge of the graph comprises:
determining a first temporal degree comprising a count of the first graph edges that (i) are incident to the respective source node, (ii) satisfy the first anchor edge direction, (iii) satisfy the first anchor edge time sequence, and (iv) have an edge time within the specified time window,
determining a second temporal degree comprising a count of the second graph edges that (i) are incident to the respective destination node, (ii) satisfy the second anchor edge direction, (iii) satisfy the second anchor edge time sequence, and (iv) have an edge time within the specified time window,
multiplying the first temporal degree by the second temporal degree to calculate an edge sampling weight for the graph edge,
summing each of the edge sampling weights to calculate a total sampling weight, and
dividing the edge sampling weight by the total sampling weight to calculate the edge sampling probability.

8. The computer-implemented method of claim 1, wherein the center edge set comprises a specified number of graph edges.

9. The computer-implemented method of claim 1, wherein randomly selecting the sample three-path comprising the center graph edge, the first respective graph edge, and the second respective graph edge further comprises:
determining that the first respective graph edge has an edge time within the specified time window from the edge time of the center graph edge, and
determining that the second respective graph edge has an edge time within the specified time window from the edge time of the center graph edge.

10. The computer-implemented method of claim 1, wherein determining the count of the temporal motif instances further comprises:
determining whether the temporal motif instance comprises four distinct nodes.

11. The computer-implemented method of claim 1, wherein determining the count of the temporal motif instances further comprises:
determining, for each motif edge not on the anchor three-path, a count of matching graph edges.

12. The computer-implemented method of claim 1, wherein calculating the motif count estimate comprises:
calculating a total count of the temporal four node motif instances comprising a sum of the count of temporal four node motif instances,
dividing the total count of the temporal four node motif instances by a count of the subset of center edges to generate a temporal motif quotient, and
multiplying the temporal motif quotient by the total sampling weight.

13. A system for estimating a temporal connected motif count in a graph, comprising:
one or more processors; and
a memory storing instructions that, when executed by the one or more processors, cause the one or more processors to:
receive an indication of a specified time window and an indication of a specified temporal motif, wherein the specified temporal motif comprises a set of motif edges, each motif edge of the set of motif edges comprises a respective source node, a respective destination node, and an edge time order;
select an anchor three-path from the specified temporal motif, wherein the anchor three-path comprises a center anchor edge, a first anchor edge, and a second anchor edge from the set of motif edges, wherein the center anchor edge and the first anchor edge are incident to a first anchor node, and the center anchor edge and the second anchor edge are incident to a second anchor node;
determine, from the specified time window and the anchor three-path, a first anchor edge direction, a first anchor edge time sequence, a second anchor edge direction, and a second anchor edge time sequence;
receive an indication of the graph, wherein the graph comprises a set of graph edges, wherein each graph edge of the set of graph edges comprises a respective graph source node, a respective graph destination node, and an edge time;
calculate an edge sampling probability for each graph edge of the graph;
randomly select, based on the edge sampling probability, a center graph edge set comprising a subset of the set of graph edges;
for each center graph edge of the center graph edge set, randomly selecting a sample three-path comprising the center graph edge, a first respective graph edge, and a second respective graph edge, wherein the center graph edge and the first respective graph edge are incident to a first respective graph node, the center graph edge and the second respective graph edge are incident to a second respective graph node, an edge direction and the edge time of the first respective graph edge satisfies the edge direction and the edge time order of the first anchor edge, and an edge direction and the edge time of the second respective graph edge satisfies the edge direction and the edge time order of the second anchor edge;
for each sample three-path, determine a count of temporal motif instances comprising the sample three-path and one or more additional graph edges satisfying the set of motif edges;
calculate the motif count estimate for the graph based on the count of the temporal motif instances; and
output the motif count estimate.

14. The system of claim 13, wherein the specified temporal motif comprises four nodes.

15. The system of claim 13, wherein the specified temporal motif comprises a motif adjacency list and the graph comprises a graph adjacency list.

16. The system of claim 13, wherein the anchor three-path comprises an edge having a lowest edge time order of the specified temporal motif.

17. The system of claim 13, wherein determining the first anchor edge direction comprises determining whether the first anchor edge is an in-edge or an out-edge of the first anchor node, and determining the second anchor edge direction comprises determining whether the second anchor edge is an in-edge or an out-edge of the second anchor node.

18. The system of claim 13, wherein determining the first anchor edge time sequence comprises determining whether the edge time order of the first anchor edge is less than or greater than the edge time order of the center anchor edge, and determining the second anchor edge time sequence comprises determining whether the edge time order of the second anchor edge is less than or greater than the edge time order of the center anchor edge.

19. The system of claim 13, wherein calculating the edge sampling probability for each graph edge of the graph comprises:
determining a first temporal degree comprising a count of the first graph edges that (i) are incident to the respective source node, (ii) satisfy the first anchor edge direction, (iii) satisfy the first anchor edge time sequence, and (iv) have an edge time within the specified time window,
determining a second temporal degree comprising a count of the second graph edges that (i) are incident to the respective destination node, (ii) satisfy the second anchor edge direction, (iii) satisfy the second anchor edge time sequence, and (iv) have an edge time within the specified time window,
multiplying the first temporal degree by the second temporal degree to calculate an edge sampling weight for the each graph edge,
summing each of the edge sampling weights to calculate a total sampling weight, and
dividing the edge sampling weight by the total sampling weight to calculate the edge sampling probability.

20. The system of claim 13, wherein the center edge set comprises a specified number of graph edges.

21. The system of claim 13, wherein randomly selecting the sample three-path comprising the center graph edge, the first respective graph edge, and the second respective graph edge further comprises:
determining that the first respective graph edge has an edge time within the specified time window from the edge time of the center graph edge, and
determining that the second respective graph edge has an edge time within the specified time window from the edge time of the center graph edge.

22. The system of claim 13, wherein determining the count of the temporal motif instances further comprises:
determining whether the temporal motif instance comprises four distinct nodes.

23. The system of claim 13, wherein determining the count of the temporal motif instances further comprises:
determining, for each motif edge not on the anchor three-path, a count of matching graph edges.

24. The system of claim 13, wherein calculating the motif count estimate comprises:
calculating a total count of the temporal four node motif instances comprising a sum of the count of temporal four node motif instances,
dividing the total count of the temporal four node motif instances by a count of the subset of center edges to generate a temporal motif quotient, and
multiplying the temporal motif quotient by the total sampling weight.
